(19) United States
(12) Patent Application Publication
(10) Pub. No.: US 2010/0085939 A1
(43) Pub. Date: Apr. 8, 2010

(54) METHOD FOR SUPPORTING MOBILITY FOR VERTICAL HANDOVER OF MOBILE NODE

(76) Inventors: Tae-Wan You, Daejeon (KR); Seung-Yun Lee, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/517,409

(22) PCT Filed: Sep. 14, 2007
(86) PCT No.: PCT/KR07/04445

§ 371 Date: Dec. 3, 2009

(30) Foreign Application Priority Data
Dec. 4, 2006 (KR) 10-2006-0121826

(51) Int. Cl. H04W 36/12; H04L 12/28

(52) U.S. Cl. 370/331; 370/401; 370/338

(57) ABSTRACT

A method for supporting mobility for a vertical handover of a mobile node (MN) includes dividing service domains of respective first and second networks in different layers when an external correspondent node (CN) and the MN communicate with each other through the first network. When the MN moves to the second network, a care of address (CoA) newly allocated from the second network and a home address (HoA) of a home agent 2 (HA2) of the second network are acquired and managed as the communication access information. The acquired CoA and HoA are registered in the HA2 and a home agent 1 (HA1) of the first network, respectively. Upon receipt of a data transporting request, the HA1 transports the data to the HA2 based on the registered HoA of the HA2. The HA2 transports the data to the MN based on the registered CoA.

### TECHNICAL FIELD

The present invention relates to a method for supporting mobility for a handover of a mobile node and, more particularly, to a method for supporting mobility for a vertical handover between mobile networks using multiple home agents.

### BACKGROUND ART

Network technology will be developed toward a single network system incorporating various access technologies based on the Internet protocol (IP). A central technology of such network development will be an IP version 6 (IPv6). Since those nodes that are actually provided with services are miniaturized and mobile, various services can be provided ubiquitously to the nodes through an incorporated network system.

Nodes connected to a next generation network system include interfaces for multiple communication connections, and each of the interfaces is applied with different access technologies. Such nodes need to be installed with one representative mobile protocol, mobile IPv6 or network mobility (NEMO) basic support, to attain the mobility of the nodes.

The mobile IPv6 can support transparency above a transport layer when a mobile node moves to a foreign network instead of a home network. A client node that supports the mobile IPv6 is allocated with a home address (HoA), which is an identifier of the client node, from a home agent (HA) of the home network. The client node attempts to bind the allocated HoA with a care of address (CoA), which is newly allocated for each movement of the client node. Such IP addresses including the HoA and the newly allocated CoA are bound together through the HA, so that intended services can be continuously provided to the mobile client node.

The NEMO basic support protocol can provide continuous connectivity to a mobile network systemized inside an airplane or a train. The NEMO basic support protocol extends the mobile IPv6, and supports mobility of a network through a new server, specifically called a mobile router (MR).

However, the aforementioned two protocols may not effectively support a network environment in which one node that includes multiple interfaces applied with different access technologies is allocated with multiple HoAs and a new CoA.

Specifically, these two protocols often have a limitation in supporting a vertical handover between the individual interfaces, because these two protocols are designed considering only the mobility of a node having a single address within a domain using a single access technology.

Hence, these two protocols may not simultaneously register numerous addresses allocated to a node with multiple interfaces, and support changes between the addresses. Home networks and HAs may exist individually on a domain representing various access technologies, and under this condition, multiple HoAs may not be used as well.

The mobile nodes and multiple interfaces in IPv6 (MONAMI6) working group of the Internet engineering task force (IETF) are developing a protocol that can register multiple CoAs and use the registered CoAs by extending the mobile IPv6. However, a method of utilizing the multiple HAs and HOAs have still not mentioned.

FIG. 1 is a diagram illustrating a method for conducting a handover between heterogeneous networks when HAs exist individually in each of multiple access technology domains of a mobile node.

Nodes 12 and 22 with multiple interfaces may individually include home networks 10, 20, and 30 and home agents 14, 24 and 34 based on corresponding access technologies.

The home agents 14, 24 and 34 manage the domains for the corresponding access technologies. Thus, each of the nodes 12 and 22 includes multiple HAs and multiple HoAs. When the nodes 12 and 22 move to a foreign network, the nodes 12 and 22 can acquire CoAs newly allocated to respective interfaces. Thus, the nodes 12 and 22 can include multiple CoAs.

When the multiple HAs 14, 24, and 34 and HoAs exist, the correspondent node (CN) 12 is more likely to access the mobile node (MN) 22 of a user. In contrast, if the HoAs change, a current communication session is often disconnected.

Also, when a node moves from one service domain to another service domain, the currently assigned HA-based mobile IPv6 and a new HA-based mobile IPv6 for supporting the mobility of the other service domain generally need to be operated in the same node for a continuous connection of a current communication session.

Currently, the MONAMI6 working group is developing a protocol that can register and use multiple newly allocated CoAs among multiple HoAs and the multiple newly allocated CoAs, which are allocated due to the existence of multiple interfaces. However, when a node moves from one service domain to another service domain, the registration of the multiple newly allocated CoAs may not be sufficient for the above described limitation. Rather, contexts need to be exchanged naturally between the HAs, which manage the mobility of the individual service domains.

### DISCLOSURE OF INVENTION

### Advantageous Effects

According to various embodiments of the present invention, when multiple home agents (HAs) of different communication networks exist in a mobile node (MN) with multiple communication access interfaces, the MN registers Home address (HoA) information, acquired from the newly moved network, in the HA of the previous network through a binding cache message. Also, a message, which is requested to be transported to the MN from a correspondent node (CN) that is accessed to the previous network for communications, is transported to the MN through the HAs of the previous network and the newly moved networks based on the HoA information of the newly moved network registered in the HA of the previous network. As a result, a vertical handover of the MN can be managed in a hierarchical structure of double layers, so that accessibility to the MN with the multiple interfaces can be improved, and mobility of different service domains can be naturally supported.

Also, the hierarchical mobility management can allow the reduction in signaling overheads or synchronization between the HAs unnecessary for communications.

Furthermore, service management can be naturally linked between the HAs for various policies of the different service domains by extending a mobile protocol, which basically needs to be provided to an appropriate MN in a ubiquitous environment. Therefore, the mobility of the MN can be dynamically managed according to a communication session instead of the operation of a mobile protocol for each of the HAs. Accordingly, the continuous communication mobility of the MN can be provided and managed without overheads even though a vertical handover takes place.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a diagram illustrating a method for conducting a handover between heterogeneous networks when HAs exist individually in each of multiple access technology domains of a mobile node;

FIG. 2 is a diagram illustrating exemplary data managed by a mobile node with multiple communication interfaces corresponding to domains for different access technologies according to an embodiment of the present invention;

FIG. 3 illustrates interface state information included in each access technology of a MN according to embodiment of the present invention;

FIG. 4 illustrates a procedure of transferring packets to a MN in the conventional mobile IPv6;

FIG. 5 is an explanatory diagram illustrating generation of a communication network for managing the mobility during the conduction of a vertical handover of a MN and management thereof according to an embodiment of the present invention;

FIG. 6 illustrates a procedure of registering HoAs allocated for the hierarchical mobility when a vertical handover of a MN is conducted according to an embodiment of the present invention;

FIG. 7 is a diagram illustrating the case of inserting identification information (i.e., R flag) into BU and binding acknowledgement messages of the conventional mobile IPv6 to register a new HoA according to an embodiment of the present invention; and

FIG. 8 is a diagram illustrating a path of transferring packets from an external CN to a MN after the registration of HoAs as described in FIGS. 6 and 7 when a vertical handover of the MN is conducted.

### BEST MODE FOR CARRYING OUT THE INVENTION

Hereinafter, preferred embodiments of the present invention will be described in detail with reference to the attached drawings. In the drawings, like reference numerals represent like elements wherever possible. Also, detailed description of the conventional functions and configuration, which may make the scope of the present invention ambiguous, will be omitted.

A mobile node according to an embodiment of the present invention includes multiple communication interfaces representing different access technologies, each being defined with a home network and a home agent (HA).

Thus, the mobile node includes multiple home addresses (HoAs). In particular, a method for registering HoAs with a newly allocated care of address (CoA) is suggested in an embodiment of the present invention. This method is advantageous of managing the hierarchical mobility of the mobile node. Also, the suggested method can prevent an occurrence of incidence in which two of the mobile Internet protocol version 6 (IPv6) are operated in one mobile node. For this effect, the HAs and the mobile node add a new option to a binding update (BU) message and register the HoAs. The registered HoAs are identified as a boundary address, which identifies a domain, and thus, being capable of performing the hierarchical management.

The multiple HAs and HoAs defined due to the fact that the mobile node includes the multiple interfaces are registered with a newly allocated CoA, and a vertical handover can be conducted in a hierarchical manner. Through this conduction, accessibility to a target network through the multiple HAs can be achieved, and the mobility management can be effectively managed in one node. The overall mobility is also allowed directly using policies for HAs defined for each access technology.

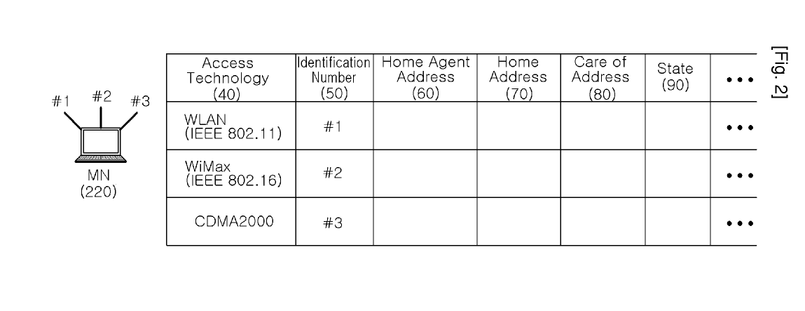

FIG. 2 is a diagram illustrating exemplary data managed by a mobile node with multiple communication interfaces corresponding to domains for different access technologies according to an embodiment of the present invention.

A mobile node (MN) 220 includes multiple interfaces representing different access technologies 40. More specifically, the MN 220 includes multiple interfaces representing access technologies 40 including a wireless local area network (WLAN) denoted as IEEE 802.11, worldwide interoperability for microwave access (WiMax) denoted as IEEE 802.16, and code divisional multiple access (CDMA) 2000.

The MN 220 manages pieces of binding cache entry information for each of the access technologies 40. Each piece of the binding cache entry information includes pieces of information about an interface number 50, a home agent address 60, a HoA 70, a newly allocated CoA 80, and interface state information 90 for each of the access technologies 40.

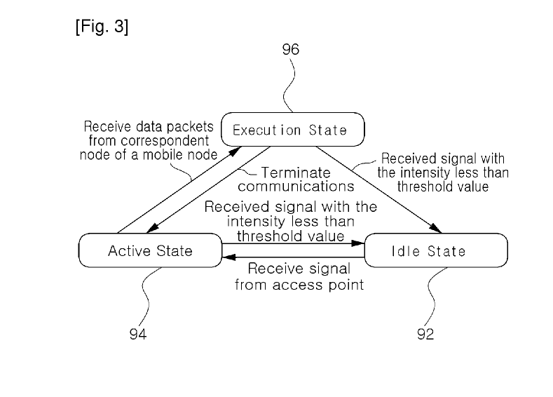

FIG. 3 illustrates interface state information included in each access technology of a MN according to embodiment of the present invention.

The MN 220, which manages the binding cache entry information including the pieces of the information about the interface number 50, the home agent address 60, the HoA 70, the newly allocated CoA 80, and the interface state information 90 for each of the access technologies 40 as illustrated in FIG. 2, manages the state information using the intensity of a signal associated with access points (APs) for each of the access technologies 40.

The state information managed by the MN 220 includes a piece of idle state information 92, a piece of active state information 94, and a piece of execution state information 96.

The idle state information 92 represents a state in which the corresponding AP does not receive a signal, and indicates that the interface in the idle state can no longer be used. The active state information 94 represents a state in which a signal with the intensity greater than a certain threshold value is received from the corresponding AP, and indicates that the corresponding interface can be used. For instance, a newly allocated CoA can be acquired in response to the signal reception with a certain level of intensity. The execution state information 96 represents a state in which the MN 220 receives data packets through actual communications.

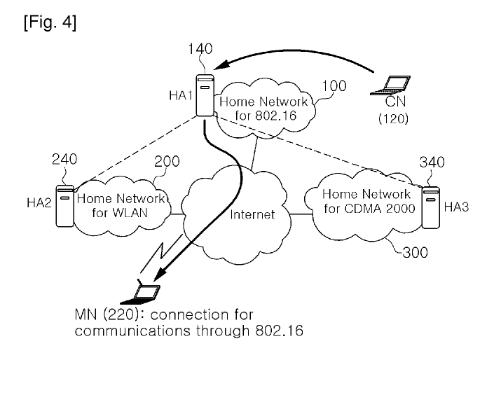

FIG. 4 illustrates a procedure of transferring packets to a MN in the conventional mobile IPv6.

When the MN 220 is placed in a service domain for a network 100 for the 802.16 standard, if a correspondent node (CN) 120 starts a communication session, the communications proceed as defined in the conventional mobile IPv6.

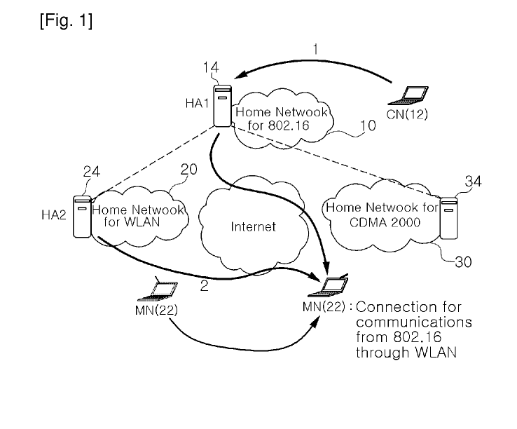

If the MN 220, which is communicating with a target network, moves to a new network using another interface for the WLAN 200, the MN 220 attempts to make a connection for communications through procedures 1 and 2 illustrated in FIG. 1. In other words, the MN 220 often has an overhead incurred due to the need of simultaneously operating a protocol based on a HA1 140 and a protocol based on a HA2 240 for providing mobility of a new domain in order for the MN 220 to communicate with the conventional external CN 120.

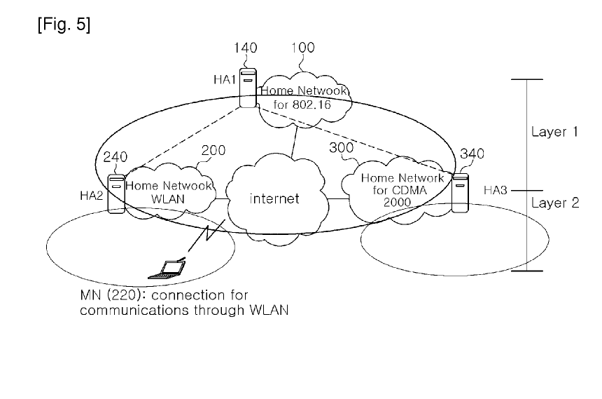

FIG. 5 is an explanatory diagram illustrating generation of a communication network for managing the mobility during the conduction of a vertical handover of a MN and management thereof according to an embodiment of the present invention.

When HAs for respective multiple access technologies exist individually, double layer-based hierarchical management is attempted. Whenever an external CN makes a request, the double layers are dynamically generated and managed.

For instance, in the case as illustrated in FIG. 5, when the MN 220 is connected to a network 100 for the 802.16 standard, a HA1 140, which manages a service domain for the 802.16 standard, is placed in the upper most layer, i.e., layer 1, because the communication session is connected to the network 100 by the external CN.

When the MN 220 moves the above service domain to another service domain for another access technology such as a WLAN 200 or CDMA 2000 300, a HA2 240 or a HA3 340 is allocated to a layer 2.

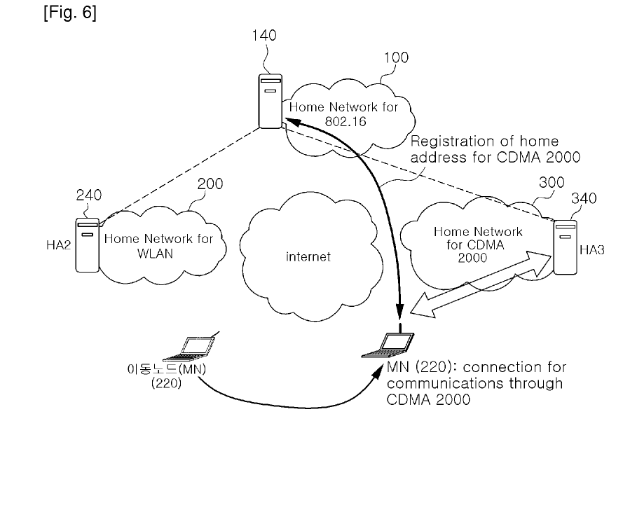

FIG. 6 illustrates a procedure of registering HoAs allocated for the hierarchical mobility when a vertical handover of a MN is conducted according to an embodiment of the present invention.

When the MN 220 moves from one service domain to another service domain, as similar to a method for registering a newly allocated CoA, a HoA, which is acquired from a home network managing the other service domain for a certain access technology, is registered in a HA managing the previous service domain for another certain access technology to construct the HAs in two layers (i.e., layer 1 and layer 2).

In the present embodiment, a piece of new optional identification information R is defined and inserted into binding update (BU) and binding acknowledgement messages of the binding cache information in order to distinguish this registration method from the CoA registration method.

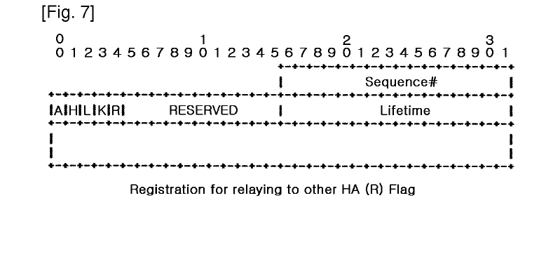

FIG. 7 is a diagram illustrating the case of inserting identification information (i.e., R flag) into BU and binding acknowledgement messages of the conventional mobile IPv6 to register a new HoA according to an embodiment of the present invention.

As similar to the registration method of a newly allocated CoA, the address registered using the R flag is defined as administrative domain boundary address (BoA) in the present embodiment. In other words, when the MN 220 moves from one service domain to another service domain, the MN 220 registers a newly acquired CoA in the HA of the other service domain through the BU message, and simultaneously registers the HoA of the other service domain in the previous HA while marking the BU message with the R flag to indicate the domain change.

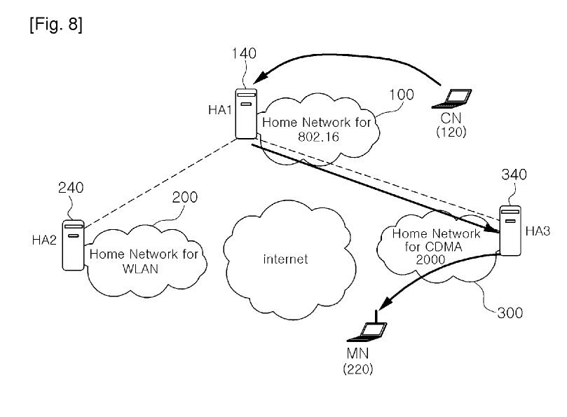

FIG. 8 is a diagram illustrating a path of transferring packets from an external CN to a MN after the registration of HoAs as described in FIGS. 6 and 7 when a vertical handover of the MN is conducted.

After the HoAs are registered as described in the embodiment of the present invention, packets are transferred from the external CN 120 to the MN 220.

More specifically, to transfer the data to the MN 220, the external CN 120 transfer data through a HoA of a home network 100 for the 802.16 standard where a HA1 140 is placed.

The HA1 140 receives the data transferred from the external CN 120 and detects information corresponding to the MN 220 in a binding cache list of the HA1 140. Thus, the HA1 140 transports the message received at the external CN 120 to a HA3 340 using a HoA of a home network 300 for CDMA 2000 where the HA3 registered by the MN 220 is placed.

The HA 340 receives the data transported from the HA1 140, and transports the received data through the registered address in which the MN 220 is currently placed.

As described in the exemplary embodiments above, when multiple HAs exist in the MN with multiple interfaces representing different access technologies, the BoA information defined according to the embodiment of the present invention is registered so as to allow the management of a vertical handover in two hierarchical layers.

Although the preferred embodiments of the present invention have been disclosed for illustrative purpose, those skilled in the art will appreciate that various modifications, additions and substitutions can be made without departing from the scope and spirit of the invention as defined in the accompanying claims.

### Mode for the Invention

An aspect of the present invention is to provide a method for supporting mobility of a mobile node for supporting a vertical handover of different service domains for a mobile node between heterogeneous networks.

Another aspect of the present invention is to provide a method for supporting mobility of a mobile node for supporting a vertical handover of different service domains by effectively registering and using multiple home agents (HAs) and home addresses (HoAs) allocated due to the existence of multiple communication interfaces of the mobile node.

According to an aspect of the invention, the invention provides a method for supporting mobility for a vertical handover of a mobile node, the method including: dividing communication service domains of respective first and second networks in different layers when an external correspondent node and the mobile node, including different communication access information for heterogeneous networks, communicate with each other through the first network among the heterogeneous networks; when the mobile node moves from the first network to the second network, acquiring a care of address (CoA) newly allocated from the second network, and a home address (HoA) of a home agent 2 (HA2) providing a communication service of the second network and managing the acquired CoA and HoA as the communication access information; registering the acquired CoA in the HA2 and the acquired HoA in a home agent 1 (HA1) providing a communication service of the first network; upon receipt of a request to transport data from the external correspondent node to the mobile node at the HA1, the HA1 transporting the data to the HA2 of the second network based on the registered HoA of the HA2; and at the HA2, transporting the data transported from the HA1 to the mobile node based on the registered CoA.

1. A method for supporting mobility for a vertical handover of a mobile node, the method comprising:
dividing communication service domains of respective first and second networks in different layers when an external correspondent node and the mobile node, including different communication access information for heterogeneous networks, communicate with each other through the first network among the heterogeneous networks;
when the mobile node moves from the first network to the second network, acquiring a care of address (CoA) newly allocated from the second network, and a home address (HoA) of a home agent 2 (HA2) providing a communication service of the second network and managing the acquired CoA and HoA as the communication access information;
registering the acquired CoA in the HA2 and the acquired HoA in a home agent 1 (HA 1) providing a communication service of the first network;
upon receipt of a request to transport data from the external correspondent node to the mobile node at the HA 1, the HA 1 transporting the data to the HA2 of the second network based on the registered HoA of the HA2; and
at the HA2, transporting the data transported from the HA1 to the mobile node based on the registered CoA.

2. The method according to claim 1, wherein the communication access information comprises binding cache entry information set for a connection for communications according to each of communication access modes of the mobile node for the heterogeneous networks.

3. The method according to claim 2, wherein the binding cache entry information comprises pieces of information about an interface number for communication access of the mobile terminal, a home agent address corresponding to the interface number, a HoA, and a newly allocated CoA according to each of the communication access modes for the heterogeneous networks.

4. The method according to claim 3, wherein the binding cache entry information further comprises state information of each of the multiple interfaces according to each of the communication access modes for the heterogeneous networks.

5. The method according to claim 4, wherein the state information of each of the multiple interfaces are managed through the intensity of a signal for each of access points (APs) according to each of the communication access modes of the heterogeneous networks.

6. The method according to claim 5, wherein the state information of each of the multiple interfaces comprises pieces of information about an idle state, an active state, and an execution state according to a state of each of the multiple interfaces.

7. The method according to claim 6, wherein the state information of each of the multiple interfaces is set to be in the idle state when the corresponding interface is not used because the corresponding AP does not receive a signal directed to the mobile node.

8. The method according to claim 6, wherein the state information of each of the multiple interfaces is set to be in the active state when the corresponding AP receives a signal directed to the mobile node and has the intensity greater than a threshold value.

9. The method according to claim 6, wherein the state information of each of the multiple interfaces is set to be in the execution state when the mobile terminal receive data through actual communications.

10. The method according to claim 2, wherein the acquired HoA is registered in the HA1 of the first network by inserting identification information, which is called an R flag, into binding update and binding acknowledgement messages of the binding cache entry information.
